(19) United States
(12) Patent Application Publication
(10) Pub. No.: US 2020/0102697 A1
(43) Pub. Date: Apr. 2, 2020

(54) SHEET AND METHOD OF MANUFACTURING THE SAME

(71) Applicants: ZEON CORPORATION, Chiyoda-ku Tokyo (JP); Hirose Paper Mfg Co., Ltd., Tosa-shi Kochi (JP); Toyota Tsusho Matex Corporation, Osaka-shi Osaka (JP)

(72) Inventors: Tomoko YAMAGISHI, Chiyoda-ku, Tokyo (JP); Mitsugu UEJIMA, Chiyoda-ku, Tokyo (JP); Tomoya NISHIUCHI, Tosa-shi, Kochi (JP); Naruaki TAKAHASHI, Minato-ku, Tokyo (JP)

(73) Assignees: ZEON CORPORATION, Chiyoda-ku Tokyo (JP); Hirose Paper Mfg Co., Ltd., Tosa-shi Kochi (JP); Toyota Tsusho Matex Corporation, Osaka-shi Osaka (JP)

(21) Appl. No.: 16/621,452

(22) PCT Filed: Sep. 21, 2018
(86) PCT No.: PCT/JP2018/035116

§ 371 Date: Dec. 11, 2019

(30) Foreign Application Priority Data
Sep. 28, 2017 (JP) 2017-189156

(51) Int. Cl. D06M 11/74; H01B 1/24

(52) U.S. Cl. CPC D06M 11/74; D10B 2401/16; D10B 2101/122; H01B 1/24

(57) ABSTRACT

Disclosed is a sheet which comprises a fibrous substrate and carbon nanotubes attached to fibers constituting the fibrous substrate. The carbon nanotubes in the sheet comprise single-walled carbon nanotubes as a main component.

### TECHNICAL FIELD

The present disclosure relates to sheets and methods for manufacturing the same, and in particular, to sheets containing carbon nanotubes and methods of manufacturing the same.

### BACKGROUND

Recently, carbon nanotubes (hereinafter also referred to as “CNTs”) have attracted attention as materials that are lightweight as well as have excellent electrical conductivity and mechanical properties. However, because fibrous carbon nanostructures such as CNTs are fine structures with sizes of nanometers in diameter, they are not necessarily easy to handle or process when used alone. One proposed approach to address such a problem is to apply CNTs onto a substrate to form a sheet for use in various applications such as, for example, electromagnetic wave absorption. As specific examples of the sheet, PTL 1 discloses a sheet obtained by forming on a surface of fibrous structures a layer which contains multi-walled carbon nanotubes, a binder and other components. Further, PTL 2 discloses a sheet obtained by applying onto a substrate a coating solution which contains multi-walled carbon nanotubes and a resin component.

### CITATION LIST

### Patent Literature

PTL 1: WO2015093600

PTL 2: JP2012174833A

### SUMMARY

### Technical Problem

However, conventionally proposed sheets such as those described above have had room for improvement in enhancing electrical conductivity and in sufficiently reducing the detachment of carbon nanotubes from the sheet.

An object of the present disclosure is therefore to provide a carbon nanotube-containing sheet which has excellent electrical conductivity and from which carbon nanotubes are less likely to detach.

Another object of the present disclosure is to provide a sheet manufacturing method which enables favorable manufacture of a carbon nanotube-containing sheet which has excellent electrical conductivity and from which carbon nanotubes are less likely to detach.

### Solution to Problem

The inventors have made extensive studies to solve the problem set forth above. As a result, they established that a sheet wherein carbon nanotubes comprising single-walled carbon nanotubes as a main component are attached to fibers has excellent electrical conductivity as well as may favorably retain the carbon nanotubes. The inventors thus completed the present disclosure.

Specifically, the present disclosure aims to advantageously solve the problem set forth above, and the disclosed sheet comprises a fibrous substrate and carbon nanotubes attached to fibers constituting the fibrous substrate, wherein the carbon nanotubes comprise single-walled carbon nanotubes as a main component. Such a sheet has excellent electrical conductivity and also carbon nanotubes are less likely to detach from the sheet.

The phrase “carbon nanotubes comprise single-walled carbon nanotubes as a main component” or equivalents as used herein means that the proportion by mass of single-walled carbon nanotubes is greater than 50% by mass based on the total mass (100%) of carbon nanotubes included in the sheet.

In the disclosed sheet, it is preferred that the single-walled carbon nanotubes have a BET specific surface area of 600 m²/g or more. When the single-walled carbon nanotubes have a BET specific surface area of 600 m²/g or more, it is possible to further improve the electrical conductivity of the sheet and also more effectively reduce the detachment of the carbon nanotubes from the sheet.

The term “BET specific surface area” as used herein refers to a nitrogen adsorption specific surface area as measured by the BET (Brunauer-Emmett-Teller) method.

It is also preferred that the disclosed sheet does not comprise a binding material (binder). When the sheet does not comprise a binder, it is possible to further improve the electrical conductivity of the sheet.

It is also preferred that the disclosed sheet has a density of 0.20 g/cm³ or more and 0.80 g/cm³ or less. A sheet having a density that falls within this range has even better electrical conductivity and also easily carry metal particles or the like thereon because it has lower density than so-called Buckypaper. The term “density” as used herein for a sheet means a mass per unit volume of the sheet and can be measured by the method described in Examples set forth herein.

In the disclosed sheet, it is preferred that the carbon nanotubes have an amount per unit area of 10 g/m² or more. When the amount per unit area of carbon nanotubes is not less than the lower limit, it is possible to further improve the electrical conductivity of the sheet and also increase the mechanical strength of the sheet.

The amount per unit area of carbon nanotubes herein can be measured by the method described in Examples set forth herein.

It is also preferred that the disclosed sheet has an electrical conductivity of 30 S/cm or more. The “electrical conductivity” of the sheet herein can be measured by the method described in Examples set forth herein in accordance with JIS K 7194:1994.

The present disclosure aims to advantageously solve the problem set forth above, and the disclosed method of manufacturing a sheet is a method of manufacturing any of the sheets described above and comprises: dispersing in a dispersion medium carbon nanotubes which comprise single-walled carbon nanotubes having a BET specific surface area of 600 m²/g or more to prepare a carbon nanotube dispersion liquid; contacting the fibrous substrate with the carbon nanotube dispersion liquid to provide a primary sheet; and removing the dispersion medium from the primary sheet. In the disclosed sheet manufacturing method, a sheet is manufactured using a dispersion liquid prepared using single-walled carbon nanotubes having a BET specific surface area of 600 m²/g or more. Thus, any of the disclosed sheets described above can be favorably manufactured.

In the disclosed sheet manufacturing method, it is preferred that the carbon nanotube dispersion liquid used in the contacting step does not comprise a binder. By contacting a fibrous substrate with a carbon nanotube dispersion liquid which does not comprise a binder in the contacting step for the manufacture a sheet, it is possible to further improve the electrical conductivity of the resulting sheet.

### Advantageous Effect

According to the present disclosure, it is possible to provide a carbon nanotube-containing sheet which has excellent electrical conductivity and from which carbon nanotubes are less likely to detach.

According to the present disclosure, it is also possible to provide a sheet manufacturing method which enables favorable manufacture of a carbon nanotube-containing sheet which has excellent electrical conductivity and from which carbon nanotubes are less likely to detach.

### DETAILED DESCRIPTION

Embodiments of the present disclosure will be described in detail below.

The disclosed sheet comprises a fibrous substrate and carbon nanotubes attached to fibers constituting the fibrous substrate, wherein the carbon nanotubes comprise single-walled carbon nanotubes as a main component. The disclosed sheet may optionally comprise additional components such as binders, carbonaceous materials other than carbon nanotubes, and additives used for sheet manufacturing. The state where carbon nanotubes are “attached” to fibers constituting the fibrous substrate herein does not simply mean a state where a layer consisting of carbon nanotubes is formed adjacent to the fibrous substrate, but means a state where carbon nanotubes are present on the fibrous substrate while being attached to, or entangled with, fibers which are constituent units of the fibrous substrate. In the disclosed sheet, it is preferred that carbon nanotubes are attached not only to fibers located on the surface of the fibrous substrate, but also to fibers located inside the fibrous substrate. This is because such a structure provides a favorable electrically conductive network that passes through the sheet from one side to the other side and thereby further improves the electrical conductivity of the sheet.

Fibers constituting the fibrous substrate that may constitute the disclosed sheet are not limited to a particular type and examples thereof include organic fibers. Examples of organic fibers include synthetic fibers made of polymers such as polyvinyl alcohol, vinylon, polyethylene vinyl alcohol, polyethylene glycol, polyvinyl pyrrolidone, poly-ϵ-caprolactone, polyacrylonitrile, polylactic acid, polycarbonate, polyamide, polyimide, polyethylene, polypropylene, polyethylene terephthalate, and modified products thereof; and natural fibers such as cotton, linen, wool, and silk. To form synthetic fibers, these polymers may be used singly or in combination of two or more kinds. Preferred fibers used to constitute the fibrous substrate are synthetic fibers, with fibers made of polyethylene terephthalate or vinylon, an acetalized polyvinyl alcohol, being more preferred. The fibrous substrate used herein may be a woven or non-woven fabric which may be constituted of any of these fibers. In particular, it is preferred that the fibrous substrate used herein is a non-woven fabric. The term “nonwoven fabric” as used herein refers to a sheet, web or batt of directionally or randomly oriented fibers, bonded to each other by entanglement, and/or cohesion and/or adhesion, excluding paper or products which are woven, knitted, tufted and felted, as defined in JIS L 0222:2001.

The fibrous substrate that may constitute the disclosed sheet preferably has an air permeability of 5 cc/cm²/s or more, which may be 500 cc/cm²/s or less. The air permeability of the fibrous substrate is more preferably 10 cc/cm²/s or more and 300 cc/cm²/s or less. The use of a fibrous substrate having an air permeability that is not less than the lower limit value described above allows CNTs to easily enter the interior of the fibrous substrate, facilitating the formation of a favorable electrically conductive network and further enhancing the electrical conductivity of the sheet. Moreover, the use of a fibrous substrate having an air permeability that is not greater than the upper limit value described above facilitates the formation of a favorable electrically conductive network while reducing the detachment of CNTs entered the interior of the fibrous substrate, making it possible to further enhance the electrical conductivity of the sheet.

The carbon nanotubes (CNTs) included in the disclosed sheet comprise single-walled carbon nanotubes (single-walled CNTs) as a main component. Examples of other possible components to be included in the CNTs include multi-walled carbon nanotubes (multi-walled CNTs). The proportion of single-walled CNTs based on the total mass of the CNTs needs to be greater than 50% by mass, preferably 90% by mass or more, more preferably 95% by mass or more, and may be 100% by mass. When the CNTs comprise multi-walled CNTs, the multi-walled CNTs preferably have 5 or fewer walls.

While it is not clear why the disclosed sheet wherein CNTs comprising single-walled CNTs as a main component are attached to fibers constituting the fibrous substrate can reduce the detachment of the CNTs while achieving favorable electrical conductivity, a possible mechanism is as follows: First, single-walled CNTs themselves have higher electrical conductivity than multi-walled CNTs. Thus, when single-walled CNTs are included as a main component of CNTs included in the sheet, the sheet shows increased electrical conductivity compared to conventional sheets which comprise multi-walled CNTs as a main component of CNTs. Further, single-walled CNTs easily interact with each other and with multi-walled

CNTs, fibrous substrate, and other targets. These interactions allow the CNTs to be more strongly retained by the fibrous substrate. Surprisingly, the studies made by the inventors also revealed that the CNTs included in the disclosed sheet can increase the sheet thickness uniformity when they comprise single-walled CNTs as a main component.

The following describes suitable attributes of CNTs, which attributes preferably hold true both for CNTs employed as a material used to manufacture the disclosed sheet, and CNTs included in the disclosed sheet. More specifically, in principle, as least values of BET specific surface area and average diameter, etc., are never less than those for CNTs used as a material, even after various treatments included in the sheet manufacturing method described later have been performed.

The CNTs are not limited to a particular type and can be produced by any CNT synthesis methods known in the art, such as arc discharge, laser ablation, or chemical vapor deposition (CVD). Specifically, the CNTs can be efficiently produced for example by the super growth method (see WO2006/011655), wherein during synthesis of CNTs through chemical vapor deposition (CVD) by supplying a feedstock compound and a carrier gas onto a substrate having thereon a catalyst layer for carbon nanotube production, the catalytic activity of the catalyst layer is dramatically improved by providing a trace amount of an oxidizing agent (catalyst activating material) in the system. Hereinafter, carbon nanotubes obtained by the super growth method may also be referred to as “SGCNTs.”

The CNTs preferably exhibit a convex upward shape in a t-plot obtained from an adsorption isotherm.

The growth of an adsorbed layer of nitrogen gas for materials having pores at the surface is divided into the following processes (1) to (3). The gradient of the t-plot changes according to processes (1) to (3):

(1) a process in which a single molecular adsorption layer is formed over the entire surface by nitrogen molecules;

(2) a process in which a multi-molecular adsorption layer is formed in accompaniment to capillary condensation filling of pores; and

(3) a process in which a multi-molecular adsorption layer is formed on a surface that appears to be non-porous due to the pores being filled by nitrogen.

A t-plot having a convex upward shape shows a straight line crossing the origin in a region in which the average adsorbed nitrogen gas layer thickness t is small. However, as t increases, the plot deviates downward from the straight line. CNTs which exhibit such a t-plot curve have a large internal specific surface area relative to total specific surface area of the CNTs, indicating the presence of a large number of openings formed in the CNTs. As a result, when a dispersion liquid is prepared using such CNTs, the CNTs are less likely to aggregate in the dispersion liquid and hence a sheet can be obtained which is homogeneous and from which CNTs are less likely to detach.

The t-plot measured for CNTs preferably has a bending point in a range of 0.2≤t (nm)≤1.5, more preferably in a range of 0.45≤t (nm)≤1.5, and even more preferably in a range of 0.55≤t (nm)≤1.0. CNTs whose bending point of a t-plot falls within these ranges are much less likely to aggregate in a dispersion liquid of the CNTs. As a result, when such a dispersion liquid is used, it is possible to obtain a sheet which is more homogeneous and from which CNTs are much less likely to detach.

The “position of the bending point” is an intersection point of an approximate straight line A for process (1) and an approximate straight line B for process (3).

The CNTs preferably have a ratio of internal specific surface area S2 to total specific surface area S1 (S2/S1) of 0.05 or more and 0.30 or less, obtained from a t-plot. CNTs whose S2/S1 value falls within this range are much less likely to aggregate in a dispersion liquid of the CNTs. As a result, it is possible to obtain a sheet which is more homogeneous and from which CNTs are much less likely to detach.

Total specific surface area S1 and internal specific surface area S2 of CNTs can be found from its t-plot. Specifically, first, total specific surface area S1 can be found from the gradient of an approximate straight line corresponding to process (1) and external specific surface area S3 can be found from the gradient of an approximate straight line corresponding to process (3). Internal specific surface area S2 can then be calculated by subtracting external specific surface area S3 from total specific surface area S1.

Measurement of adsorption isotherm, preparation of a t-plot, and calculation of total specific surface area S1 and internal specific surface area S2 based on t-plot analysis for CNTs can be made using for example BELSORP®-mini (BELSORP is a registered trademark in Japan, other countries, or both), a commercially available measurement instrument available from Bel Japan Inc.

The CNTs preferably have a BET specific surface area of 600 m²/g or more, and more preferably 800 m²/g or more, but preferably 2,000 m²/g or less, more preferably 1,800 m²/g or less, and even more preferably 1,600 m²/g or less. When the BET specific surface area falls within these ranges, it is possible to more effectively reduce the detachment of the carbon nanotubes from the sheet. While it is not clear why CNTs having a BET specific surface area in the specified ranges have such an effect, a possible mechanism is as follows: First, the use of CNTs having a BET specific surface area that is not less than the lower limit described above allows a moderate level of adsorption action to be exerted between the CNT and the fibrous substrate and among the CNTs, whereby the detachment of carbon nanotubes from the sheet can be more effectively reduced. Secondly, while it is assumed that CNTs having a high BET specific surface area are CNTs which are prone to detach due for example to their shortness or presence of many “cuts,” the use of CNTs having a BET specific surface area that is not greater than the upper limit described above prevents inclusion of such CNTs that are prone to detach and therefore detachment of carbon nanotubes from the sheet can be more effectively reduced.

The CNTs preferably have an average diameter of 1 nm or more, but preferably 60 nm or less, more preferably 30 nm or less, and even more preferably 10 nm or less.

The CNTs preferably have an average length of 10 μm or more, more preferably 50 μm or more, and even more preferably 80 μm or more, but preferably 600 μm or less, more preferably 500 μm or less, and even more preferably 400 μm or less.

CNTs having an average diameter and/or an average length that fall within the respective ranges described above are less likely to aggregate in a dispersion liquid of the CNTs. It is thus possible to obtain a sheet which is more homogeneous and from which CNTs are much less likely to detach.

The CNTs usually have an aspect ratio (length/diameter) of more than 10.

The average diameter, average length and aspect ratio of CNTs can be obtained based on the diameters and lengths of 100 randomly-selected CNTs as measured by scanning electron microscopy or transmission electron microscopy.

From the perspective of enhancing the electrical conductivity of the disclosed sheet, it is preferred that the sheet does not comprise a binder. If a binder is to be included in the sheet, the binder may be, for example, a polyester resin or other known adhesive resin.

The disclosed sheet may comprise additives or other agents used during manufacture of the sheet. Examples of such additives include dispersants which may be used to disperse CNTs during manufacture of the sheet. It is preferred that the dispersant is removed during the sheet manufacturing process, so that the disclosed sheet does not comprise a dispersant.

The disclosed sheet preferably has a density of 0.20 g/cm³ or more, and more preferably 0.45 g/cm³ or more, but preferably 0.80 g/cm³ or less, and more preferably 0.75 g/cm³ or less. When the disclosed sheet has a density that is not less than the lower limit described above, it is possible to further enhance the electrical conductivity of the sheet. On the other hand, when the disclosed sheet has a density that is not greater than the upper limit described above, it is possible to avoid the sheet from being overly “clogged.” This allows the sheet to be suitably used in applications where functional materials are supported on the sheet for conferring a desired function to the sheet. More specifically, as functional materials, for examples, particles made of metal such as tin, platinum, gold or palladium, or metal oxide such as silicon oxide, lithium oxide or lithium titanate can be favorably supported in pores of the sheet. The diameter of such particles is not limited to a particular value and may be, for example, 5 μm or less.

The density of the sheet can be measured by the method described in Examples described later. The density of the sheet may be calculated based on the total mass of the sheet including the fibrous substrate and carbon nanotubes. In other words, the density of the sheet can be controlled by changing the type of the fibrous substrate used and the amount per unit area of carbon nanotubes described later.

It is also preferred that the amount per unit area of carbon nanotubes of the disclosed sheet is 10 g/m² or more. When the amount per unit area of carbon nanotubes is not less than the lower limit, it is possible to further enhance the electrical conductivity of the sheet. The amount per unit area of carbon nanotubes may be, for example, 100 g/m² or less. Methods of controlling the amount per unit area of carbon nanotubes will be described later in relation to the sheet manufacturing method.

It is also preferred that the disclosed sheet has an electrical conductivity of 30 S/cm or more, and more preferably 35 S/cm or more. A sheet having an electrical conductivity of 30 S/cm or more can exhibit a sufficient electrical conductivity and therefore can be suitably used for example as an electromagnetic wave absorbing material. Electrical conductivity is the reciprocal of resistivity. The electrical conductivity of the sheet can be controlled for example by changing the amount per unit area of carbon nanotubes and the type of carbon nanotubes in the sheet.

The disclosed sheet can be favorably manufactured in accordance with the disclosed sheet manufacturing method. The disclosed sheet manufacturing method may include: a CNT dispersion liquid preparation step wherein carbon nanotubes which comprise single-walled carbon nanotubes having a BET specific surface area of 600 m²/g or more are dispersed in a dispersion medium to prepare a carbon nanotube dispersion liquid; a contacting step wherein a fibrous substrate is contacted with the carbon nanotube dispersion liquid to provide a primary sheet; and a dispersion medium removal step wherein the dispersion medium is removed from the primary sheet. In the disclosed sheet manufacturing method, a CNT dispersion liquid is prepared using CNTs which comprise single-walled CNTs having a BET specific surface area of 600 m²/g or more, and the CNT dispersion liquid is applied to a fibrous substrate to form a sheet. With this configuration, it is possible to favorably manufacture a sheet having high electrical conductivity and high detachment resistance of CNTs. Each step will be described in detail below. It should be noted that the disclosed sheet can be manufactured not only by such a sheet manufacturing method, but also by various sheet manufacturing methods so long as they are able to manufacture a sheet which may have an essential configuration and a suitable configuration such as those described. For example, it is possible to manufacture such a sheet by subjecting fibers such as those described above to CNT attachment treatment and then forming a fibrous substrate using the treated fibers.

In the CNT dispersion liquid preparation step, CNTs which comprise single-walled CNTs having a BET specific surface area of 600 m²/g or more are dispersed into a dispersion medium to prepare a CNT dispersion liquid. Single-walled CNTs and other CNTs which can be used include single-walled CNTs and multi-walled CNTs such as those described above. The CNTs may comprise single-walled CNTs as a main component. The dispersion medium is not limited to a particular type and usable dispersion media include water, isopropanol, 1-methyl-2-pyrrolidone, dimethylformamide, dimethylsulfoxide, dimethylacetamide, toluene, tetrahydrofuran, ethyl acetate, acetonitrile, ethylene glycol, methyl isobutyl ketone, and butyl alcohol, with water being a preferred dispersion medium.

In the CNT dispersion liquid preparation step, a dispersant can be added as an additive in order to increase the dispersibility of CNTs in the CNT dispersion liquid. The dispersant is not limited to a particular type and examples thereof include surfactants known in the art, such as sodium dodecylsulfonate, sodium deoxycholate, sodium cholate, and sodium dodecylbenzenesulfonate; and synthetic or natural polymers which may function as a dispersant. The dispersant can be added in an amount that falls within a common range.

In the CNT dispersion liquid preparation step, CNTs are added into a dispersion medium containing a surfactant such as that described above to prepare a crude dispersion liquid, and then a dispersing method which can provide a cavitation effect such as that disclosed in WO2014/115560 and/or a dispersing method which can provide a disintegration effect are/is applied to the crude dispersion liquid. In this way a CNT dispersion liquid can be obtained which has a good dispersibility of CNTs. The dispersing method is not limited to these two methods. As a matter of course, dispersing can also be accomplished by directly stirring the CNTs with a stirrer.

Optionally, additional components such as binders, carbonaceous materials other than carbon nanotubes, and additives may be added into the CNT dispersion liquid. When such optional components are to be added, they may be added into the crude dispersion liquid, for example. As described above, it is preferred that the CNT dispersion liquid is free of a binder from the viewpoint of increasing the electrical conductivity of the resulting sheet.

The dispersing time in the CNT dispersion preparation step can be, for example, 1 minute or more and 20 minutes or less.

In the contacting step, a fibrous substrate is contacted with the CNT dispersion liquid to afford a primary sheet in which CNTs are attached to or retained on the fibrous substrate. The contacting method is not limited to a particular method so long as it is capable of contacting at least one side, preferably both sides, of the fibrous substrate with the CNT dispersion liquid. Examples of contacting methods include, for example, immersing the fibrous substrate into the CNT dispersion liquid, and spraying the CNT dispersion liquid on the fibrous substrate. Conditions such as time and temperature required for the contacting step are not limited to particular ones and can be determined as desired according to, for example, the desired amount per unit area of CNTs. It is preferred that the CNT dispersion liquid used in the contacting step does not comprise a binder. Specifically, it is preferred a binder is not added into the CNT dispersion liquid not only in the dispersion liquid preparation step as described above, but also at any timing between immediately after the dispersion liquid preparation step and immediately before the contacting step.

In the dispersion medium removing step, the dispersion medium is removed from the primary sheet. The removing method is not limited to a particular method and any desired removing method can be applied. Here, some of the CNTs contained in the primary sheet are retained within the fibrous substrate by direct or indirect interactions with the surface of the fibrous substrate, and others may be floating in the dispersion medium remaining in the fibrous substrate. Naturally, the former CNTs are more strongly fixed to the fibrous substrate than the latter CNTs. In the dispersion medium removing step, the latter CNTs may be removed together with the dispersion medium. Alternatively, as a result of the dispersion medium being removed in the dispersion medium removing step, the latter CNTs may be allowed to interact with at least one of the fibrous substrate and the CNTs which are strongly fixed to the fibrous substrate. Conditions such as time and temperature in the dispersion medium removing step can be determined as desired according to the type of the dispersion medium used and the properties of the fibrous substrate used.

A washing step can be optionally performed after the dispersion medium removing step. By performing such a washing step, when the CNT dispersion liquid contains a dispersant as an optional component, the dispersant can be removed from the sheet. By performing a washing step under any desired condition, the CNTs can be adjusted to have a desired amount per unit area. Moreover, by performing a washing step to remove CNTs which are weakly fixed to the fibrous substrate, it is possible to more effectively reduce the detachment of CNTs from the sheet by increasing CNTs that remain fixed to the fibrous substrate in the resulting sheet.

Solvents used for washing are not limited to a particular type and usable solvents include organic solvents such as isopropyl alcohol and various solvents described above as dispersion media which can be used to prepare the dispersion liquid. Among them, water is preferred. The washing method is not limited to a particular type and washing can be effected for example by contacting the CNT attached-surface of the fibrous substrate with a dispersion medium.

Conditions such as the number of washings and washing temperature can be determined according to, for example, the properties of the fibrous substrate and the desired amount per unit area of CNTs.

A drying step is then performed to dry the primary sheet. In this way the disclosed sheet is obtained. The drying method is not limited to a particular method and examples thereof include hot air drying, vacuum drying, hot roll drying, and infrared irradiation. The drying temperature is not limited to a particular value but is usually from room temperature to 200° C. The drying time is not limited to a particular value but is usually 1 hour to 48 hours.

The disclosed sheet obtained as described above has excellent electrical conductivity and also CNTs are less likely to detach from the sheet.

### EXAMPLE S

The present disclosure will be described in more detail below based on Examples, which however shall not be construed as limiting the scope of the present disclosure.

In Examples and Comparative Examples, the BET specific surface area of CNTs, the amount per unit area of CNTs, and the density, electrical conductivity, and powder drop resistance of the sheet were evaluated using the methods described below.

<BET Specific Surface Area>

The BET specific surface area of CNTs as a material used in each of Examples and Comparative Examples was measured using a full automatic BET specific surface area analyzer (Macsorb® HM model-1210 (Macsorb is a registered trademark in Japan, other countries, or both), manufactured by MOUNTECH Co., Ltd.).

<Amount Per Unit Area of CNTs>

The sheet manufactured in each of Examples and Comparative Examples was cut to 5 cm×5 cm (area: 25 cm²) to prepare a test piece. The total amount of attached CNTs W^{CNT} (g), obtained by weighing the mass W^{S} (g) of the test piece and subtracting the mass W^{f} (g) of the fibrous substrate used for the manufacture of the sheet, was divided by the area of the test piece to calculate the amount per unit area of CNTs as the amount (g) attached per 1 m² area of the test piece.

<Sheet Density>

The sheet manufactured in each of Examples and Comparative Examples was cut to 5 cm×5 cm to prepare a test piece. The thickness of each test piece was measured by a micrometer to calculate the volume (cm³) of the test piece. The mass W^{S} (g) of the test piece calculated in the same manner as described in <Amount Per Unit Area of CNTs> above was then divided by the volume (cm³) of the test piece to calculate the density (g/cm³) of the sheet.

<Electrical Conductivity of Sheet>

The electrical conductivity of each of the sheets manufactured in Examples and Comparative Examples was determined by the four probe method (method using probes placed on one side of the sheet) using a low resistivity meter (Loresta® GX (Loresta is a registered trademark in Japan, other countries, or both), Mitsubishi Chemical Analytech Co., Ltd.) in accordance with JIS K 7194:1994.

<Powder Drop Resistance>

The powder drop resistance of the sheet manufactured in each of Examples and Comparative Examples was evaluated as follows: The upper end of the sheet was fixed on a flat table with an adhesive tape and a white gauze with a 50 g weight placed thereon was allowed to slide on the sheet. The surface of the white gauze was visually observed and evaluated based on the criteria given below. Good powder drop resistance means that the sheet is less likely to cause CNT detachment.

A: No attachment of black powder (i.e., CNTs) on the white gauze

B: Attachment of black powder (i.e., CNTs) on the white gauze

<Uniformity of Sheet Thickness>

For the sheet manufactured in each of Examples and Comparative Examples, the thickness was measured at 5 points and a variation (3σ) was calculated. The uniformity of sheet thickness was evaluated based on the following criteria:

A: −0.05≤3σ≤0.05

B: 3σ<−0.05 or 0.05<3σ

### Example 1

<Preparation of Carbon Nanotube Dispersion Liquid>

Using sodium dodecylbenzenesulfonate (SDBS) as a dispersant and water as a dispersion medium, 500 mL of a 1 mass % aqueous solution of SDBS was prepared. As single-walled CNTs, 1.0 g of SGCNTs (ZEONANO® SG101 (ZEONANO is a registered trademark in Japan, other countries, or both), manufactured by Zeon Nano Technology Co., Ltd., BET specific surface area: 1,050 m²/g, average diameter: 3.3 nm, average length: 400 t-plot has a convex upward shape (the position of the bending point: 0.6 nm), the ratio of internal specific surface area S2 to total specific surface area S1: 0.24) was added to the aqueous solution to afford a crude dispersion liquid containing SDBS as a dispersant. The crude dispersion liquid containing single-walled CNTs was loaded into a high-pressure homogenizer (BERYU SYSTEM PRO, manufactured by BERYU Co., Ltd.) having a multi-stage pressure controller (multi-stage pressure reducer) that applies a back pressure during dispersing, and dispersing treatment of the crude dispersion liquid was performed at a pressure of 100 MPa. Specifically, the CNTs were dispersed by applying a shearing force to the crude dispersion liquid while applying a back pressure to afford an SGCNT dispersion liquid having a concentration of 0.2% by mass. The dispersing treatment was performed for 10 minutes while returning back the dispersion liquid flowing out from the high-pressure homogenizer to the high-pressure homogenizer.

<Contacting Step to Washing Step>

A 5 cm×5 cm vinylon nonwoven fabric (product code: VN1036, manufactured by Hirose Paper Mfg Co., Ltd., air permeability: 40 cc/cm²/s) as a fibrous substrate was immersed into the 0.2 mass % SGCNT dispersion liquid obtained as described above and dried at normal temperature for 3 hours. The obtained vinylon nonwoven fabric was washed with isopropyl alcohol (IPA) and then with pure water.

<Drying Step>

The primary sheet (vinylon nonwoven fabric containing SGCNTs) obtained from the washing step was dried under vacuum at 80° C. for 24 hours to afford a sheet in which SGCNTs, single-walled CNTs, are attached to vinylon fibers constituting the vinylon nonwoven fabric, a fibrous substrate. Various measurements and evaluations were performed on the obtained sheet in accordance with the methods described above. The results are given in Table 1.

### Example 2

A sheet was obtained as in Example 1 except that as a fibrous substrate, a PET nonwoven fabric (product code: 05TH-36, manufactured by Hirose Paper Mfg Co., Ltd., air permeability: 20 cc/cm²/s) was used instead of a vinylon nonwoven fabric. Various measurements and evaluations were performed on the obtained sheet in accordance with the methods described above. The results are given in Table 1.

### Example 3

A sheet was obtained as in Example 2 except that conditions in the contacting step and washing step to manufacture the sheet were changed. Various measurements and evaluations were performed on the obtained sheet in accordance with the methods described above. The results are given in Table 1.

### Comparative Example 1

A sheet was obtained as in Example 2 except that 1.0 g of multi-walled CNTs (NC7000, manufactured by Nanocyl SA, BET specific surface area: 290 m²/g, average diameter: 9.5 nm, average length: 1.5 μm, t-plot is flat) was added instead of single-walled CNTs. Various measurements and evaluations were performed on the obtained sheet in accordance with the methods described above. The results are given in Table 1.

TABLE 1

| | | CNT | | Amount per | | | Evaluation | |
|---|---|---|---|---|---|---|---|---|
| | | | Specific | unit area of | | Electrical | Powder | |
| | Fibrous | | surface area | CNT | Density | conductivity | drop | Thickness |
| | substrate | Type | (m²/g) | (g/m²) | (g/cm²) | (S/cm) | resistance | uniformity |
| Example 1 | Vinylon | SWCNT | 1050 | 48 | 0.54 | 85 | A | A |
| Example 2 | PET | SWCNT | 1050 | 51 | 0.72 | 105 | A | A |
| Example 3 | PET | SWCNT | 1050 | 10 | 0.67 | 37 | A | A |
| Comparative | PET | MWCNT | 290 | 37 | 0.59 | 29 | B | B |
| Example 1 | | | | | | | | |

It can be learned from Table 1 that the sheets of Examples 1 to 3 wherein single-walled CNTs are attached to fibers constituting the fibrous substrate were able to achieve high levels of electrical conductivity and powder drop resistance. On the other hand, it can be learned from Table 1 that the sheet of Comparative Example 1 wherein multi-walled CNTs are attached to the fibrous substrate showed low electrical conductivity, was prone to cause powder drop, and was non-uniform in thickness.

### INDUSTRIAL APPLICABILITY

According to the present disclosure, it is possible to provide a carbon nanotube-containing sheet which has excellent electrical conductivity and from which carbon nanotubes are less likely to detach.

According to the present disclosure, it is also possible to provide a sheet manufacturing method which enables favorable manufacture of a carbon nanotube-containing sheet which has excellent electrical conductivity and from which carbon nanotubes are less likely to detach.

1. A sheet comprising:
a fibrous substrate; and
carbon nanotubes attached to fibers constituting the fibrous substrate,
wherein the carbon nanotubes comprise single-walled carbon nanotubes as a main component.

2. The sheet of claim 1, wherein the single-walled carbon nanotubes have a BET specific surface area of 600 m²/g or more.

3. The sheet of claim 1, wherein the sheet does not comprise a binder.

4. The sheet of any one of claims 1 to 3 claim 1, wherein the sheet has a density of 0.20 g/cm³ or more and 0.80 g/cm³ or less.

5. The sheet of claim 1, wherein the carbon nanotubes have an amount per unit area of 10 g/m² or more.

6. The sheet of claim 1, wherein the sheet has an electrical conductivity of 30 S/cm or more.

7. A method of manufacturing the sheet of claim 1, comprising:
dispersing in a dispersion medium carbon nanotubes which comprise single-walled carbon nanotubes having a BET specific surface area of 600 m²/g or more to prepare a carbon nanotube dispersion liquid;
contacting the fibrous substrate with the carbon nanotube dispersion liquid to provide a primary sheet; and
removing the dispersion medium from the primary sheet.

8. The method of manufacturing the sheet of claim 7, wherein the carbon nanotube dispersion liquid used in the contacting step does not comprise a binder.
